(19) United States
(12) Patent Application Publication
(10) Pub. No.: US 2014/0180620 A1
(43) Pub. Date: Jun. 26, 2014

(54) Calibration Artifact and Method of Calibrating a Coordinate Measuring Machine

(71) Applicant: Hexagon Metrology, Inc., North Kingstown, RI (US)

(72) Inventor: Peter Hicks, Wyoming, RI (US)

(73) Assignee: Hexagon Metrology, Inc., North Kingstown, RI (US)

(21) Appl. No.: 14/136,306

(22) Filed: Dec. 20, 2013

Related U.S. Application Data
(60) Provisional application No. 61/740,965, filed on Dec. 21, 2012.

(51) Int. Cl. G01B 11/00

(52) U.S. Cl. CPC G01B 11/005
USPC 702/95

(57) ABSTRACT

A first artifact for use in calibrating a machine-vision coordinate measurement machine includes a body with two targets at opposing ends of the body. The targets are separated by a fixed distance, and are visible to and recognizable by a camera in the coordinate measurement machine. The machine is configured to sequentially move the camera to locations above each target, and record each such camera position. As such, the artifact is useful in assessing the accuracy and calibration of the machine.

### RELATED APPLICATIONS

This patent application claims priority from provisional U.S. patent application Ser. No. 61/740,965, filed Dec. 21, 2013, entitled, “Calibration Artifact And Method Of Calibrating a Coordinate Measuring Machine,” and naming Peter Hicks as inventor [practitioner's file 3740A/1009], the disclosure of which is incorporated herein, in its entirety, by reference.

### TECHNICAL FIELD

The present invention relates to coordinate measuring machines (“CMMs”), and more particularly to calibrating coordinate measuring machines.

### BACKGROUND ART

It is known in the prior art to calibrate optical (e.g., machine-vision based) coordinate measuring machines by inspecting a calibrated object, such as a two-dimensional glass scale of certified dimensions. A two-dimensional glass scale of certified dimensions is, essentially, a glass object that includes precise graduations. In order to serve its intended purpose, both the glass object and the graduations must be of known dimensions and those dimensions must be certified by a certifying authority, such as its manufacturer or the manufacturer of a coordinate measuring machine. Such methods have a number of shortcomings, including at least the need to have a certified two-dimensional glass scale.

A mechanical coordinate measuring machine may be calibrated by causing a probe to sequentially touch pairs of spherical reference objects, but the dimensions of such spheres must be very precise. Indeed, such dimensions of such spheres must be certified in order for the spheres to be used in calibrating coordinate measuring machine. Further, the accuracy of such spheres may suffer from changes in temperature or other environmental factors. In addition, such spheres are not useful for calibrating optical coordinate measuring machines because machine vision systems are not adept at focusing on the edge of a sphere. As such, spheres and ball bars are not well suited for calibrating optical machine vision CMMs.

### SUMMARY OF THE EMBODIMENTS

A first embodiment provides a calibration artifact for use in calibrating a machine-vision coordinate measuring machine (“CMM”). The artifact includes a base having base length, and a top surface defining a base plane; a first target coupled to the top surface of the base; and a second target coupled the base, the second target separated from the first target by a nominal distance along the length.

In some embodiments, the second target is in the base plane, while in other embodiments the second target is in a second plane parallel to, but displaced from, the base plane.

In various embodiments, the length of the base is fixed, but in other embodiments, the length of the base may be controllably adjustable. For example, in some embodiments, the base includes a first base member with a first target, and a second base member with a second target, and is configured such that the first base member movable with respect to the second base member. Such an embodiment may also include a locking mechanism whereby the length can be fixed, for example after the length of the artifact is adjusted to its desired value.

While a target may be integral to the base, in some embodiments, the target is affixed to, or is part of a target module that is attached to, or attachable to, the base.

A target may be a dot or point, but in some embodiments a target includes one or more concentric rings around a center point. Indeed, in some embodiments a target further resembles a bull's-eye, with a center point.

Various embodiments of artifacts may be employed as part of a method or methods for calibrating a machine-vision coordinate measuring machine, such as a coordinate measuring machine having a bed defining a bed plane, and a movable machine-vision camera. One such method includes the steps of placing a calibration artifact on the bed, such that the calibration artifact lies in the bed plane. The artifact may be any of the artifacts described above, or below, for example. The method also includes the steps of taking a first measurement, by locating the first target with the camera, and recording a first camera position data; locating the second target with the camera, and recording a second camera position data; and calculating a first measured distance between the first target and the second target. The method continues by taking a second measurement, by rotating the calibration artifact 90 degrees around an axis perpendicular to the bed plane; locating the first target with the camera, and recording a third camera position data; locating the second target with the camera, and recording a fourth camera position data; and calculating a second measured distance between the first target and the second target. The method then includes comparing the first measured distance to the second measured distance to determine whether the first measured distance is equal to the second the measured distance.

In some embodiments, the step or steps of recording a camera position comprises storing data about the camera's position along the X axis and along the Y axis and along the Z axis, and storing data relating to the focus of the camera.

A coordinate measuring machine may be described as having an object table defining a table plane and an object volume extending from the table plane. An embodiment of a calibration artifact for calibrating such an optical coordinate measuring machine includes: a base having base length, and a surface defining a base plane; a first optically visible target coupled to the base and disposed in a first plane, the first plane parallel to the base plane; and a second optically visible target and coupled the base. The second target is separated from the first target by a nominal distance along the base length, and is disposed in a second plane that is parallel to the first plane. As such, the first target and the second target are arranged to define two calibration reference points visible to and locatable by the camera when the base rests on the table. In some embodiments of the calibration artifact, the second plane is displaced from the first plane in a direction normal to the first plane.

In some embodiments, the calibration artifact also includes a vertical support coupled to the base, and configured to extend from the base into the object volume. The vertical support is coupled to the first target and suspends the first target within the object volume. In some cases, the first target is parallel to the second target. In some embodiments, the first target and the second target are not parallel to the table plane.

In some embodiments, the base length is fixed, but in other embodiments, the base length is controllably adjustable. For example, in some embodiments the base includes a first base member and a second base member. The first base member is movable with respect to the second base member, and the first target is coupled to the first member and the second target is coupled to the second member. Some embodiments include a locking mechanism whereby the base length can be fixed by engaging the locking mechanism.

The targets may take a variety of forms. For example, a first target may have a plurality of concentric rings around a center point. As another example, the first target may form a bull's-eye at the center point.

Some embodiments also include a first target module. Such a first target module includes a substrate and the first target.

Yet another embodiment is a method of calibrating a machine-vision coordinate measuring machine that has a bed defining a bed plane, and a machine-vision camera. The method includes placing a calibration artifact on the bed such that the calibration artifact lies in the bed plane. The calibration artifact may be any of the calibration artifacts described herein, for example. The method then takes a first measurement by locating the first target with the camera, and recording first position data in a computer memory, and then locating the second target with the camera and recording second position data in the computer memory. Next, the method includes rotating the calibration artifact around an axis perpendicular to the bed plane. The method next includes taking a second measurement, by locating the first target with the camera, and recording third position data of the first target in a computer memory, and locating the second target with the camera, and recording fourth position data of the second target in the computer memory.

The method then assesses the accuracy of the machine using the first position date, the second position data, the third position data, and the fourth position data. For example, in some embodiments the method calculates a first measured distance between the first target and the second target using the first position data and the second position data; and calculates a second measured distance between the first target and the second target using the third position data and the fourth target position data. Having calculated those measured distances, the method compares the first measured distance to the second measured distance to determine whether the first measured distance is equal to the second the measured distance.

In some embodiments, the step of locating the first target with the camera, and recording the position of the first target in a computer memory, includes locating the first target with the camera when the camera is spaced a fixed distance above bed plane, and recording a first camera position data; the step of locating the second target with the camera and recording the position of the second target in the computer memory includes locating the second target with the camera and recording a second camera position data; the step of locating the first target with the camera, and recording a third position of the first target in a computer memory includes locating the first target with the camera when the camera spaced a fixed distance above bed plane, and recording a third camera position data; and the step of locating the second target with the camera, and recording a third position of the second target in the computer memory, includes locating the second target with the camera, and recording a fourth camera position data.

In some embodiments, the step of recording a camera position includes storing data about the camera's position along the X axis and along the Y axis and along the Z axis, and storing data relating to the focus of the camera.

### BRIEF DESCRIPTION OF THE DRAWINGS

The foregoing features of embodiments will be more readily understood by reference to the following detailed description, taken with reference to the accompanying drawings, in which:

FIG. 1A is a photograph of a machine-vision-based coordinate measuring machine;

FIG. 1B schematically illustrates manual controls for a machine-vision-based coordinate measuring machine;

FIGS. 2A-2C schematically illustrates an embodiment of a calibration artifact;

FIG. 3 schematically illustrates an alternate embodiment of a calibration artifact;

FIG. 4 schematically illustrates an embodiment of a target;

FIG. 5A is a photograph of an alternate embodiment of a calibration artifact;

FIG. 5B schematically illustrates a side view of the calibration artifact of FIG. 5A;

FIG. 6 is a flow chart illustrating a method of calibrating a machine-vision-based coordinate measuring machine;

FIG. 7A and FIG. 7B schematically illustrate a machine-vision-based coordinate measuring machine at various stages of the method of FIG. 6 as applied to the X-Y plane;

FIG. 7C and FIG. 7D schematically illustrate an alternate embodiment of a machine-vision-based coordinate measuring machine at various stages of the method of FIG. 6 as applied to the X-Y plane;

FIG. 8A and FIG. 8B schematically illustrates a machine-vision-based coordinate measuring machine at various stages of the method of FIG. 6 as applied to the X-Z plane;

FIG. 8C and FIG. 8D schematically illustrate an alternate embodiment of a machine-vision-based coordinate measuring machine at various stages of the method of FIG. 6 as applied to the X-Z plane;

FIGS. 9A-9M schematically illustrate alternate embodiments of calibration artifacts.

### DETAILED DESCRIPTION OF SPECIFIC EMBODIMENTS

An artifact for use in calibrating a machine-vision coordinate measurement machine includes a body with two optically visible targets at different points on the body. The targets are separated by a fixed distance, and are visible to and recognizable by a camera in the coordinate measurement machine. The machine is configured to be able to sequentially move the camera to locations above each target, and record each such camera position. As such, the artifact is useful in assessing the accuracy of the machine. Various embodiments of such an artifact, along with methods of using such artifacts, are described further below.

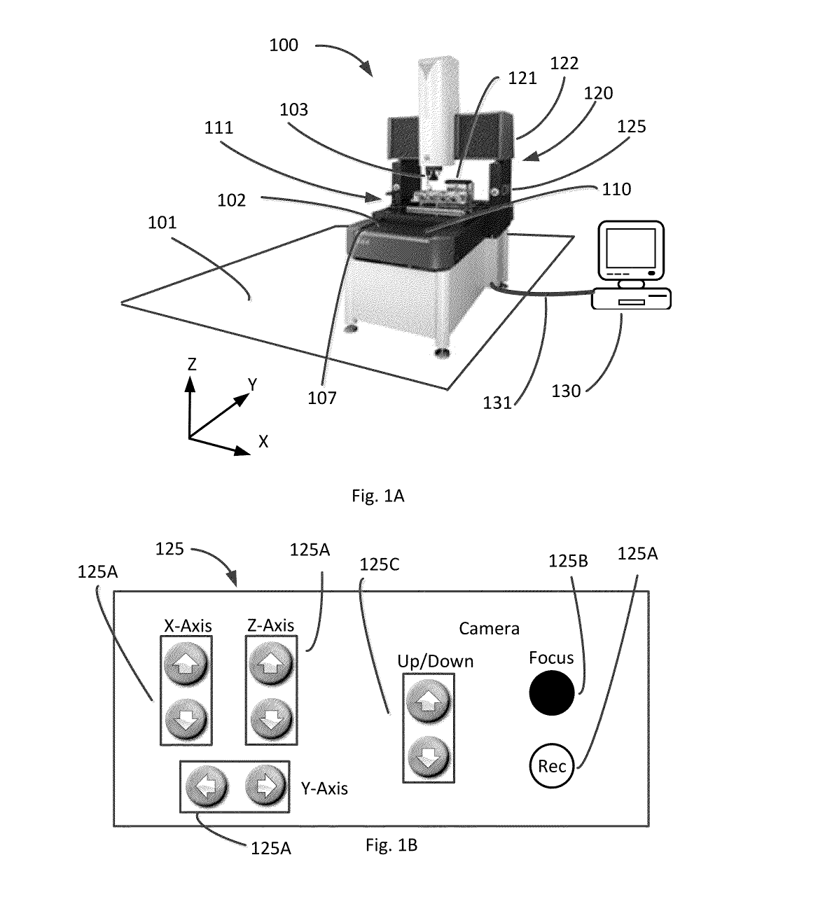

FIG. 1A is a photograph of an example of a machine-vision coordinate measurement machine 100 standing on a floor 101. A machine-vision CMM (e.g., CMM 100) may have some features in common with a mechanical CMM. For example, as is known in the art, a CMM (e.g., CMM 100 or a mechanical CMM) typically has a control system 120 that includes computer processor hardware 121 and sensors and electromechanical features 122.

A computer processor 121 may be a microprocessor, such as a member of the Intel “Core 2” family of integrated circuit microprocessors available from Intel Corporation, or a digital signal processer such as a member of the TMS320C66x family of digital signal processor integrated circuits from Texas Instruments Incorporated, to name but a few examples. A computer processor 121 may have on-board digital memory (e.g., RAM or ROM) for storing data and/or computer code including instructions for implementing some or all of the control system's operations and methods described below. Alternately, or in addition, the computer processor 121 may be operably coupled to other digital memory, such as RAM or ROM, or a programmable memory circuit, to name but a few examples, for storing such computer code and/or data.

Alternately, or in addition, in some embodiments, a machine-vision CMM 100 may be coupled to and in electronic communication with a computer (or “host computer”) 130, for example. The host computer 130 has a computer processor such as those described above, and computer memory in communication with the processor. The memory is configured to hold non-transient computer instructions capable of being executed by the processor, and/or to store non-transient data, such as data acquired as a result of the measurements described below. The host computer 130 may be a desktop computer, a tower computer, or a laptop computer, such as those available from Dell Inc., or even a tablet computer such as the iPad available from Apple Inc., for example. The host computer 130 may be coupled to the CMM via a hardwired connection, such as an Ethernet cable 131 for example, or via a wireless link such as a Bluetooth link or a WiFi link, to name but a few examples. The host computer 130 may, for example, include software to control the CMM during use or calibration, and/or may include software configured to process data acquired during a calibration process, as described further below. In addition, the host computer 130 may include a user interface configured to allow a user to manually operate the CMM.

The electromechanical features 122 of a CMM are arranged to move a measuring device, such as a mechanical probe in a mechanical CMM, or a camera 103 in a machine-vision CMM, to measure various points on an object to be measured, or to locate various points on a calibration artifact. Alternately, some CMMs move a table, such as table 102 in CMM 100, with respect to a stationary measuring device. Either way, the electromechanical features 122 of a CMM manipulate the relative positions of a measuring device and an object or artifact, with respect to one another, so as to present the object or artifact to the measuring device in a variety of ways, such that the CMM can measure a variety of locations on the object or artifact.

Because their relative positions are determined by the action of the electromechanical features 122, the CMM inherently knows the relative locations of the table, and object or artifact, with respect to the measuring device. More particularly, the computers 121 or 130 control and store information about the motions of the electromechanical features 122. Alternately, or in addition, the electromechanical features 122 of some CMMs include sensors that sense the locations of the table and/or measuring device, and report that data to the computers 121 or 130. The information about the motions and positions of the table and/or measuring device of a CMM may be recorded in terms of a two-dimensional (e.g., X-Y; X-Z; Y-Z) or three-dimensional (X-Y-Z) coordinate system referenced to a point on the CMM. For example, the reference point, or origin of the coordinate system, may be a corner 107 of the table 102, but could be any other point on the CMM.

Some CMMs also include a manual user interface 125 as shown in FIG. 1A and as further schematically illustrated in FIG. 1B, including control buttons 125A and knobs 125B for example, to allow a user to manually operate the CMM, including changing the position of the camera 103 or table 102 (e.g., with respect to one another) and to record data describing the position of the camera 103 or table 102, and/or focusing the camera on an object or target and recording data describing the focus of the camera. In a moving table CMM, the camera may also be movable via control buttons 125C. As such, the electromechanical features 122 may respond to manual control, or under control of the computer processor 121, to move the table 102 and/or a location measuring device (e.g., a mechanical probe in a mechanical CMM or a camera 103 in a machine vision CMM) relative to one another such that an object being measured by the CMM can be presented to the measuring device from a variety of angles and in a variety of positions.

A CMM (e.g., CMM 100) may be used to measure or assess an object resting on a bed 102 of the CMM 100. The accuracy of such measurements or assessments may depend on the calibration of the CMM. Generally, the bed 102 of the CMM 100 defined an X-Y plane 110 (which may be referred to as a “bed plane” or a “table plane”), that may be parallel to the plane of the floor 101.

Unlike mechanical CMMs, which locate coordinates (e.g., physical points) on an object by touching the object with a movable probe, some machine-vision CMMs locate points on an object with a controllably movable camera, such as a camera under computer control. For example, a machine-vision CMM may move a camera to a known location, such as a location directly above a point on the object, and point the camera directly at the object, for example at an angle normal to the bed 102 of the CMM. Alternately, a CMM 100 with a movable table 102 may locate points on an object by moving the table 102, thereby moving the object on the table 102, until the object is positioned below the camera 103. As such, calibrating a machine-vision CMM presents challenges not present in the calibration of a typical mechanical CMM, and known methods of calibrating a mechanical CMM are not well suited for calibrating machine-vision CMMs.

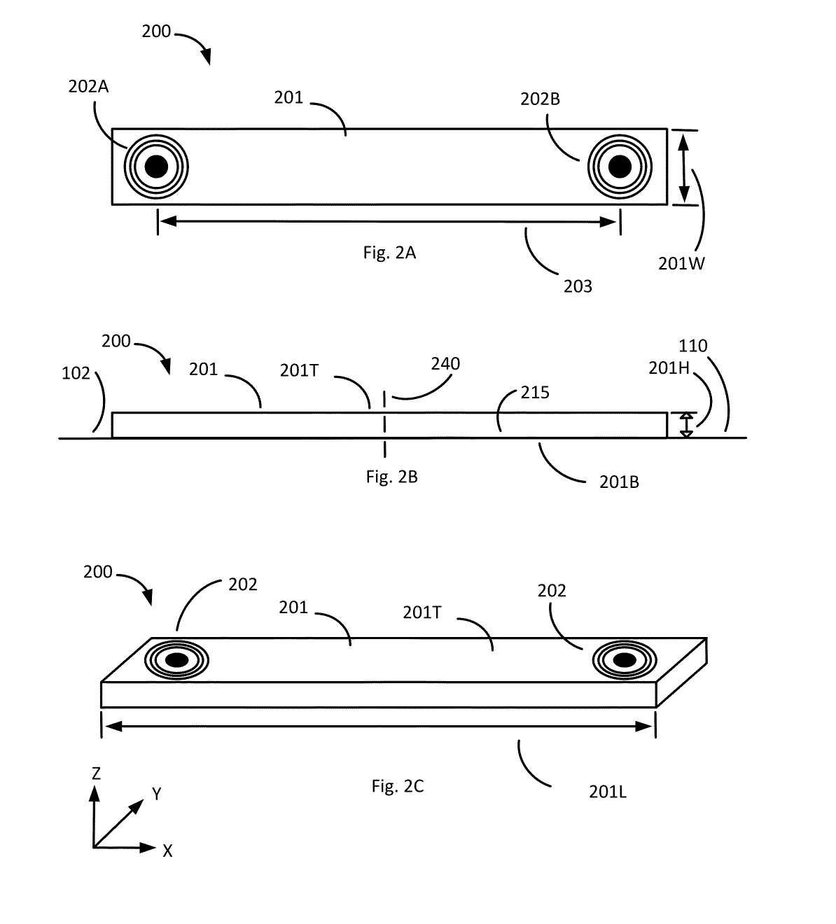

FIGS. 2A-2C schematically illustrate a plan view, a side view, and a perspective view, respectively, of an artifact or device 200 for use in calibrating a machine-vision CMM. FIG. 2C, and various other features herein, are accompanied by a two-axis or three-axis key to facilitate illustration of various axes and points of view.

The artifact 200 has a body 201 having a length, or “base length,” 201L, a width 201W and a thickness or height 201H, and is configured to lie on the bed 102 of a CMM 100. To that end, the bottom surface 201B of body 201 is flat, and defines a base plane 215, to match the flat surface of the bed 102 of a CMM 100.

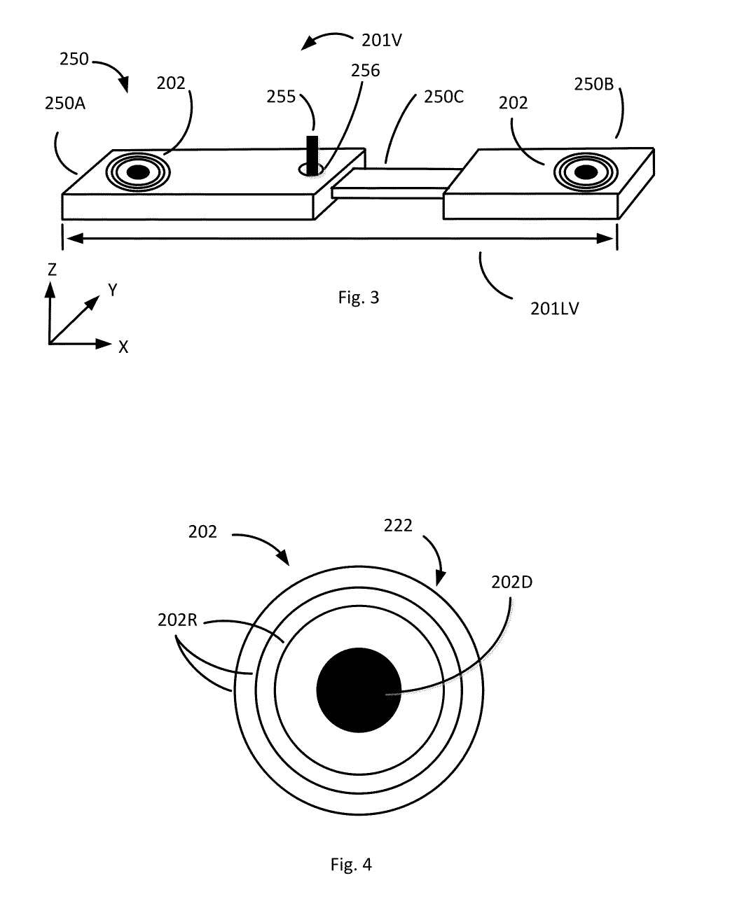

In this embodiment, the length 201L of the body 201 is fixed, but in alternate embodiments the length 201LV may be variable. For example, in some embodiments (such as artifact 250 in FIG. 3, for example), a variable-length body 201V has a first body section 250A and a second body section 250B movably coupled to the first body section 250A. In some embodiments, the first body section 250A may be movably coupled to the second body section 250B by a joining member 250C that is fixedly attached to the second body member 250B and configured to controllably slide into the first body member 250A.

A variable-length body 201V may also have a locking mechanism by which the locations of the body sections 250A and 250B may be fixed with respect to one another. For example, a locking mechanism may be a pin 255 configured to fit through an aperture 256 in the body 201V and a corresponding aperture (not shown) in joining member 250C so as to fix the positions of the body sections 250A, 250B.

A body (e.g., 201, 201V) may be made of any rigid material, such as steel or other metal, plastic, wood, to name but a few. In some embodiments the body 201 is made of a material that has a low coefficient of thermal expansion, and that does not shrink or swell in response to changes in temperature, humidity or other environmental factors that may be found in a manufacturing or engineering environment.

Embodiments of the artifact 200 include two targets 202 (for purposes of illustration, the targets are identified as items 202A and 202B), spaced from one another on the top surface 201T of artifact 200. In an artifact with a fixed-length (e.g., 201), the distance 203 between the targets 202A, 202B is also fixed. In an artifact 250 with a variable-length body (e.g., 201V) the distance 203 between the targets 202A, 202B is variable in concert with the change of length 201LV of the body 201V.

An illustrative target 202 is schematically illustrated in FIG. 4. In a preferred embodiment, each target 202A, 202B has a center dot or point 202D. In some embodiments, the dot 202D is a circle with a diameter of about 1.0 millimeter, although other shapes and dimensions may be used in alternate embodiments. In some embodiments, the center dot 202D is surrounded by one or more concentric circles 202R, in a pattern that may be known as a “bulls-eye.” A target 202 defines a plane (which may be referred to as a “target plane”), whether the target 202 consists only of a dot 202D or includes circles 202R. In FIG. 4, for example, the target plane 222 is parallel to the page. Beneficially, for use in calibrating optical CMMs according to the methods described herein, neither the targets nor any substrates on which the targets reside (e.g., target substrates 501A, 501B described below) need to be certified.

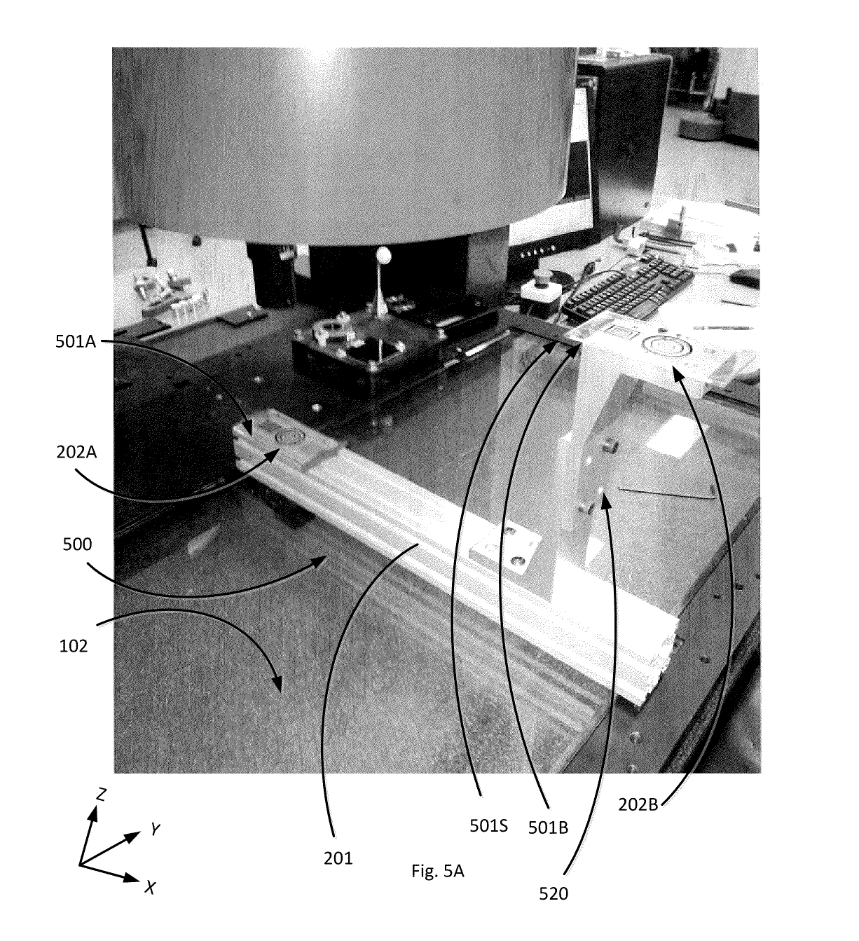

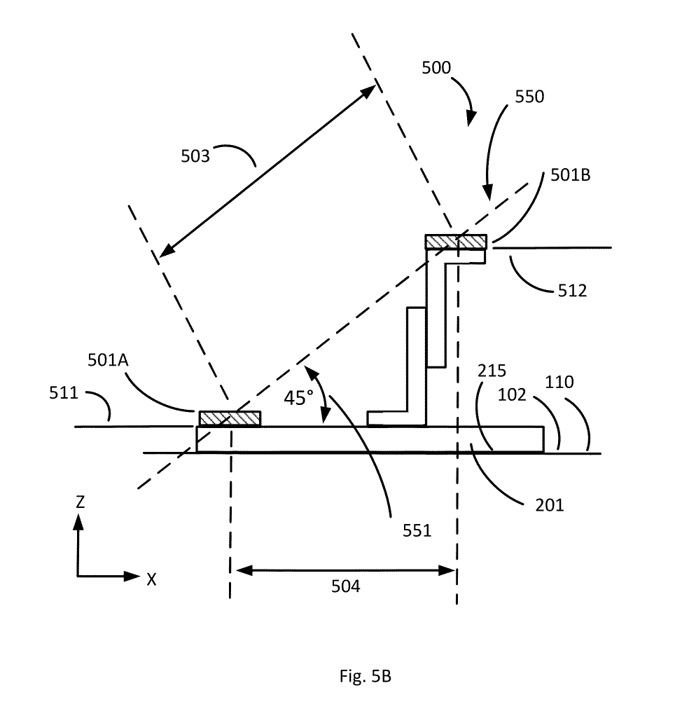

An alternate embodiment of an artifact 500 is illustrated in FIG. 5A and FIG. 5B. The artifact 500 has two targets 202A, 202B, but not in the same plane. In other words, target 202A is in a first plane 511 parallel to bed 102, but target 202B is in a second plane 512 that is parallel to the bed 102 and vertically offset (e.g., in the Z axis; or offset or displaced from the first plane 511 in a direction normal to the first plane 511) from the first plane, for example by virtue of vertical support 520. The targets 202A, 202B are separated by a distance 503 along a line 550 that intersects the dots 202D of each target 202A, 202B, and which in this example is at a 45 degree angle (551) to the first plane 511 and the second plane 512. As shown in FIG. 5B, the targets 202A and 202B are separated by a distance 504 along the base 201.

The first target 202A and the second target 202B define two calibration reference points visible to and locatable by the camera 103 when the base 201 rests on the table 102. The artifact 500 may be useful in assessing the accuracy and/or calibration of the CMM 100 in a plane normal to the plane 110 of the bed 102, such as the X-Z or Y-Z plane for example, according to the method 600 described below, for example.

In some embodiments, one or more of the targets 202A, 202B may be in or on a substrate called a “target substrate.” For example, the artifact 500 in FIG. 5 includes two target substrates 501A, 501B, each bearing a target (202A and 202B, respectively). In that embodiment, the target substrates each include a transparent or translucent substrate 501S mounted to the artifact 500.

As shown, various embodiments describe a calibration artifact (e.g. 500) for calibrating an optical coordinate measuring machine, in which the CMM has an object table (102) defining a table plane (110) and an object volume 111 extending from the table plane (110) in a direction normal to the table plane 110, and a movable camera (103). For example, object volume 111 of the CMM 100 of FIG. 1A includes the three-dimensional space between the table 102 and the camera 103. That three dimensional space may be defined as a box have a rectangular base at the table 102 and a height defined as the distance between the table 102 and the camera 103.

Such calibration artifacts include a base (e.g., 201) having base length, and a surface defining a base plane; a first optically visible target coupled to the base and disposed in a first plane, the first plane parallel to the base plane; and a second optically visible target and coupled the base. In some embodiments, the second target (e.g., 202B) is separated from the first target (e.g., 202A) by a nominal distance (e.g., 504) along the base length, and the second target is disposed in a second plane (e.g., 512), the second plane (e.g., 512) parallel to, but displaced from, the first plane (e.g., 511) in a direction normal to the first plane, and the first target (e.g., 202A) and the second target (e.g., 202B) define two calibration reference points visible to and locatable by the camera (e.g., 103) when the base (201) rests on the table (102).

In operation, the artifact (e.g., 200) may be used in a process of calibrating a CMM. Various embodiment of a method 600 are described below in calibrating a machine vision CMM with a movable camera under automated control. However, the method may also be used in calibrating a machine vision CMM with a movable table. Either way, the method 600 involves moving the relative positions of the calibration artifact and the camera. In addition, some or all of the steps in the method 600 may be performed under manual control of the camera or table, rather than under automated control by the computer processor 121.

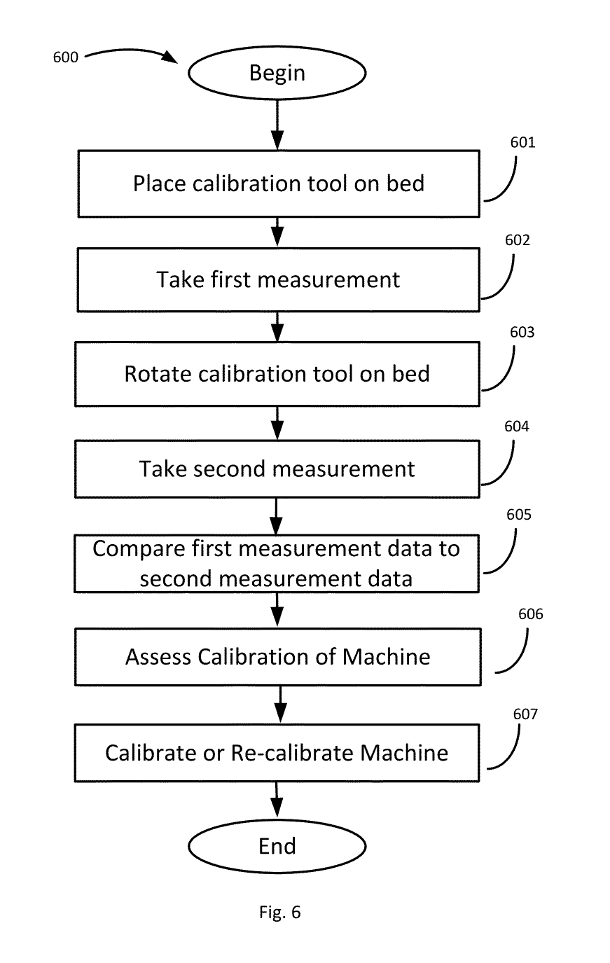

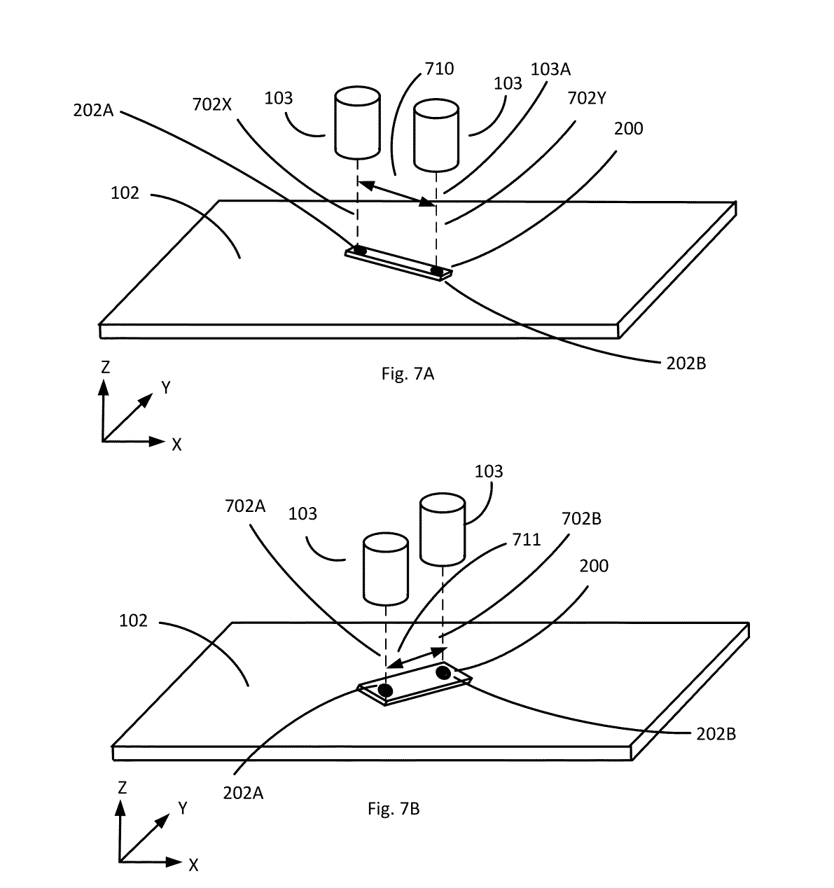

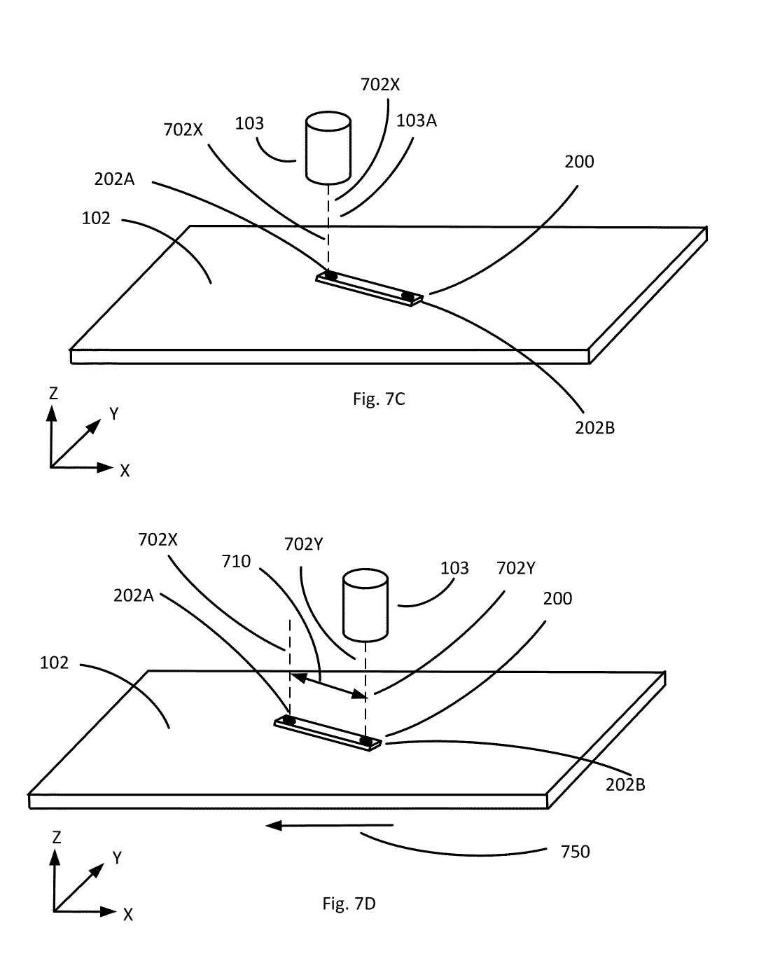

In one embodiment, a method 600 calibrates the X-Y plane of a CMM, as illustrated by flow chart in FIG. 6, along with FIG. 7A and FIG. 7B for example. In the method, an operator places (step 601) an artifact 200 on the bed 102 of a machine-vision CMM, such as CMM 100 for example, and the CMM 100 begins an automated (e.g., computer-driven) calibration assessment. The position of the artifact 200 may be known as the “initial position” (e.g., FIG. 7A).

The CMM 100 then takes a first measurement (step 602) of the artifact 200. More specifically, the CMM, and its control system, moves its machine-vision camera 103 until the camera 103 can see the target (e.g., 202A). For example, in some embodiments the control system 120 of the CMM moves the camera 103 until it is positioned directly above a target 202A (i.e., the camera's line of sight 103A is orthogonal to the plane of the target), such that the camera 103 “sees” or identifies the target 202A. If the target 202A is a bulls-eye type target, the CMM continues to operate the camera 103 until it sees or identifies the dot 202D in the bulls-eye and positions the camera such that its optical axis 103A passes through the dot 202D. In some embodiments, the camera 103 is placed a known, or measured, distance X (702X) above the target 202A. To measure the location of the target 202A, the CMM may use its sensors, or its control system's inherent knowledge of the camera's location, to measure the location of the camera 103 at that position (e.g., a “first position”) in two or three dimensions, and may then store the first position data in a computer memory.

Next, while the artifact 200 remains in the same position on the bed 102, the CMM moves the camera 103 until it sees or identifies the dot 202D of the other target 202B. In some embodiments, the camera 103 is placed a known, or measured, distance Y (702Y) above the target 202B. Note that, although FIGS. 7A and 7B include two illustrations of camera 103, these illustrations represent the same camera in two different positions.

The CMM then uses internal sensors, or its control system's knowledge of the position of the camera, to measure the location of the camera 103 at that second position (i.e., the position above the second target in two or three dimensions), and stores the second position data in a computer memory. In some embodiments, the camera distances above the targets 202 (702X, 702Y) are equal to one another.

The CMM, or more particularly a computer processor 121 within the CMM or a host processor 130, then processes the first position data and the second position data to determine the distance between the targets 202A, 202B. The measured or calculated distance may be known as the “first distance” (710).

Then the operator re-orients (step 603) the artifact 200 on the bed 102 so that the long axis (i.e., along base length 201L) of the artifact 200 remains parallel to the bed 102 but is at an angle to its previous position (the initial position). In this illustrative embodiment, the angle is a right angle, but that is not a limitation of the artifact or the use of the artifact. As such, the operator rotates the artifact 200 ninety degrees about an axis 240 (e.g., as in FIG. 2B) normal to the bed 102 (i.e., the Z axis), to a “final” position (e.g., FIG. 7B).

The operator does not change the length of the artifact 200, and in a preferred embodiment the artifact 200 is moved, and the second measurement (described below) is performed within a short time (e.g., a few minutes) of the first measurement (described above). In this way, the calibration process can proceed on the assumption that the length of the artifact 200, and therefore the distance between the targets 202A, 202B, does not change in the time interval between the two measurements.

The CMM 100 then takes a second measurement (step 604) of the artifact 200. More particularly, the CMM locates the dots 202D again, and records the respective positions of the targets 202A and 202B (e.g., by recording the position of the camera 103), accordingly. Those positions may be known as the third and fourth positions, respectively. In some embodiments, the camera 103 is placed a known, or measured, distances A (702A) and B (702B) above the targets 202, respectively. In some embodiments, the camera distances above the targets 202 (702A, 702B) are equal to one another.

The CMM then uses internal sensors, or its control system's inherent knowledge of the camera's location, to measure the location of the camera 103 at those third and fourth positions, and stores that position data (which may be known as the third position data and the fourth position data, respectively) in a computer memory. The CMM 100 (e.g., the computer 121 within the CMM) or a host processor 130 processes the third position data and the fourth position data to determine the distance between the targets 202A, 202B. The measured or calculated distance may be known as the “second distance” (711).

The CMM, or again the computer 121 within the CMM or a host processor 130, then compares the first distance 710 to the second distance 711 (step 605). An assessment (step 606) is then performed to determine the accuracy of the CMM 100. For example, any difference between the two distances 710, 711 may indicate whether, and by how much, that the CMM 100 is out of calibration, and appropriate action (607) may be taken to calibrate the CMM. Methods for assessing a CMM using that data gathered by measuring points on an artifact are known in the CMM arts. For example, such an assessment may be performed by evaluating the squareness of a CMM as described for example in U.S. Pat. No. 7,712,224, issued May 11, 2010.

Calibrating the CMM at step 607 may be performed in a variety of ways. The amount by which the two measurements differ may be used to calculate or update correction values in an error map stored in a computer memory (e.g., the computer or controller that controls the CMM). The use of error maps is well known in the CMM art, and their use and validation/correction in a mechanical CMM are described for example in U.S. Pat. No. 7,712,224, issued May 11, 2010. In short, when measuring an object on the table 102 of a CMM, the CMM (e.g., computer 121 or 130) accesses the correction value or values from the error map, and uses those values to correct the position readouts of the CMM's axes (e.g., X axis, Y axis, and/or Z axis), thereby resulting in more accurate measurements of objects than would have been achieved without correcting for errors. For example, a correction value is configured to update a measurement of, or location data describing the position of, a point on or feature of, another object. As such, the step 607 of calibrating the CMM may include updating an error map stored in a non-transient computer memory (e.g., computer 121 or 130). Alternately, the data gathered may guide a technician in determining how to adjust the electromechanical features 122 of the CMM to reduce the errors.

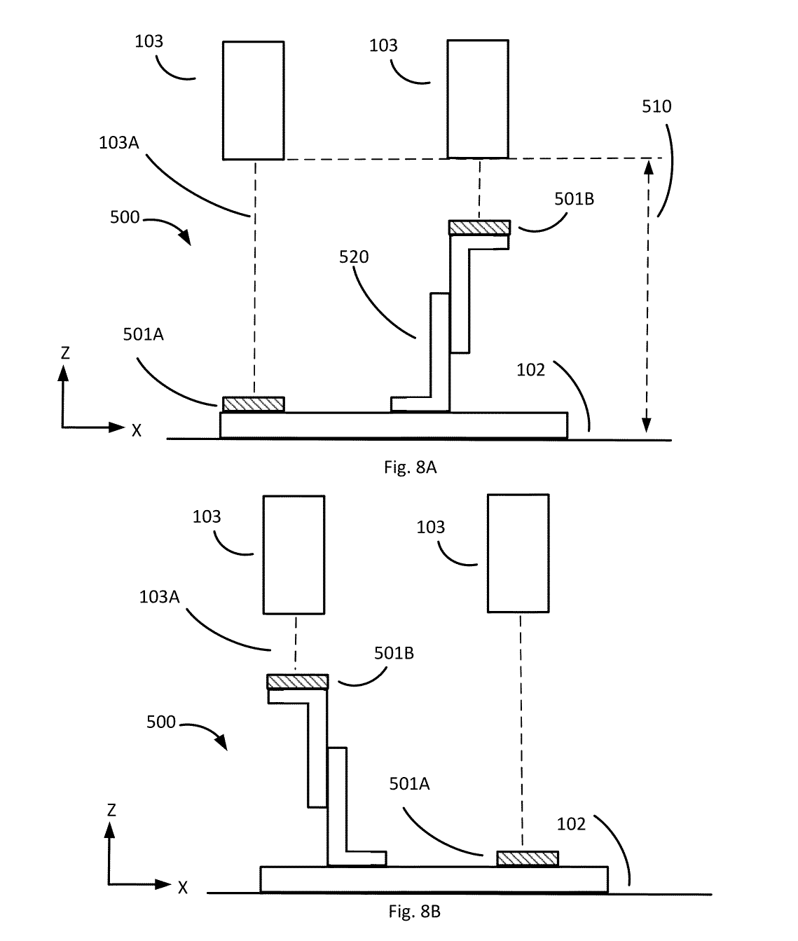

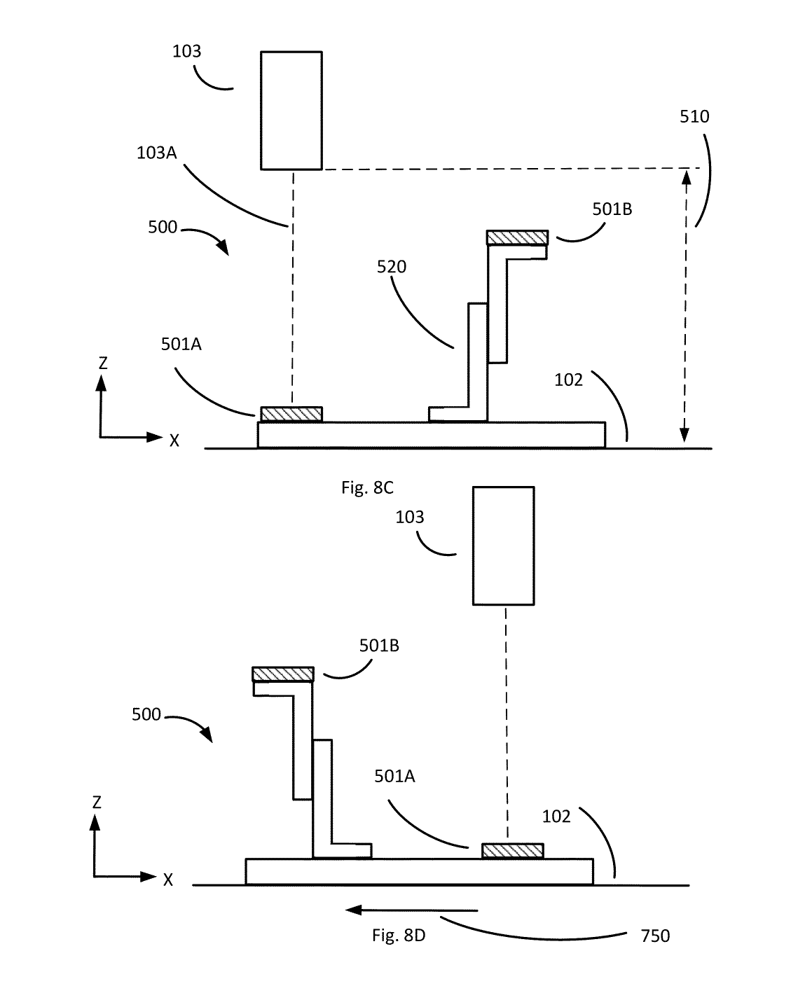

The method 600 may also be used in the calibration of the X-Z plane or the Y-Z plane of a CMM. For purposes of illustration, such a process for the X-Z plane is described below with reference to flow chart 600, and FIG. 8A and FIG. 8B.

At step 601, an operator places the calibration artifact 500 on the bed 102 of the CMM. Then the CMM begins to measure the artifact 500 by locating the positions of the target 202A (step 602). Specifically, similar to the process described above, the CMM's computer moves the camera 103 into a position such that the camera can see the target 202A, for example a position directly above the target 202A, such that the camera's optical axis 103A is orthogonal to the plane of the target, and the optical axis 103A passes directly through the dot 202D. In this position, the camera 103 is a fixed distance 510 above the bed 102. The computer, through the use of software and the camera 103, locates the center of the dot 202D of target 202A, and measures and records the position of the camera in the computer's memory. To measure the distance between the camera 103A and the dot 202D of the target 101A, the computer adjusts the lens of the camera 103 until the dot 202D comes into clear focus.

Then the computer moves the camera 103 to a position directly above the other target 202B, and locates that target's dot 202D. The computer then locates the center of the dot 202D of target 202B, and measures and records the position of the camera 103 in the computer's memory. With that data, the computer can calculate the distance 503 between the dots along line 550.

The operator then rotates the artifact 500 180 degrees on the bed 102 (step 603), as schematically illustrated in FIG. 8B. The artifact remains, essentially, in the X-Z plane.

The method 600 then takes a second measurement (step 604), essentially similar to the measurement of step 602, except with the now-rotated artifact 500. With the second set of measurement data, the computer (e.g., computer 121 or host computer 130) can again calculate the distance 503 between the dots 202D along line 550. The remaining process steps (steps 605-607) proceed as described previously. A similar process 600 may be used to calibrate the Y-Z plane.

As mentioned above, the method 600 is not limited to CMMs having a movable camera, or to steps that are all automated. For example, in an alternate embodiment, a method 600 calibrates the X-Y plane of a CMM, as illustrated by flow chart in FIG. 6, along with FIG. 7C and FIG. 7D for example. In this embodiment method, an operator places (step 601) an artifact 200 on the bed 102 of a machine-vision CMM, such as CMM 100 for example, and the CMM 100 begins an automated (e.g., computer-driven) calibration assessment. The position of the artifact 200 may be known as the “initial position” (e.g., FIG. 7C).

The CMM 100 then takes a first measurement (step 602) of the artifact 200. More specifically, the CMM, and its control system, moves the table 102 until the camera 103 can see the target (e.g., 202A). For example, in some embodiments the control system 120 of the CMM moves the table 102 until a target 202A is directly below the camera 103 (i.e., the camera's line of sight 103A is orthogonal to the plane of the target), such that the camera 103 “sees” or identifies the target 202A. If the target 202A is a bulls-eye type target, the CMM continues to operate the camera 103 until it sees or identifies the dot 202D in the bulls-eye and positions the camera such that its optical axis 103A passes through the dot 202D. To measure the location of the target 202A, the CMM may use its sensors, or its control system's inherent knowledge of the camera's location, to measure the location of the table 102 relative to the camera 103 at that position (e.g., a “first position”) and in two or three dimensions, and may then store the first position data in a computer memory.

Next, while the artifact 200 remains in the same position on the bed 102, the CMM moves the table 102 until it the camera 103 sees or identifies the dot 202D of the other target 202B. For example, in FIG. 7D, the CMM has moved the table in the direction of arrow 750 so that the target 202B is beneath the camera 103. The CMM then uses internal sensors, or its control system's knowledge of the position of the camera, to measure the location of the table 102 relative to the camera 103 at that position (e.g., a “second position”) and in two or three dimensions, and stores the second position data in a computer memory. In some embodiments, the camera distances above the targets 202 (702X, 702Y) are equal to one another.

The CMM, or more particularly a computer processor 121 within the CMM or a host processor 130, then processes the first position data and the second position data to determine the distance between the targets 202A, 202B. The measured or calculated distance may be known as the “first distance” (710).

Then the operator re-orients (step 603) the artifact 200 on the bed 102 so that the long axis (i.e., along base length 201L) of the artifact 200 remains parallel to the bed 102 but is at an angle to its previous position (the initial position), as illustrated by, and described in connection with, the rotation of the artifact 200 in connection with FIG. 7B. The CMM locates the dots 202D again, and records the respective positions of the targets 202A and 202B (e.g., by recording the position of the table 102 with respect to the camera 103), accordingly. Those positions may be known as the third and fourth positions, respectively.

The CMM then uses internal sensors, or its control system's inherent knowledge of the camera's location, to measure the location of the table at those third and fourth positions, and stores that position data (which may be known as the third position data and the fourth position data, respectively) in a computer memory. The CMM 100, e.g., the computer 121, or host computer 130, then processes the third position data and the fourth position data to determine the distance between the targets 202A, 202B. The measured or calculated distance may be known as the “second distance” (e.g., similar to the distance 711 in FIG. 7B).

The CMM, or again the computer 121 within the CMM or a host processor 130, then compares the first distance 710 to the second distance 711 (step 605). An assessment (step 606) is then performed to determine the state of accuracy of the machine, as described above in connection with FIG. 7A and FIG. 7B and the machine is calibrated using results of the assessment, as step 607.

In another embodiment, the method 600 may also be used in the calibration of the X-Z plane or the Y-Z plane of a CMM 100 with a movable table. For purposes of illustration, such a process for the X-Z plane is described below with reference to flow chart 600, and FIG. 8C and FIG. 8D.

At step 601, an operator places the calibration artifact 500 on the bed 102 of the CMM. Then the CMM begins to measure the artifact 500 by locating the positions of the target 202A (step 602). Specifically, similar to the process described above, the CMM's computer moves the table 102 into a position such that the camera 103 can see the target 202A, for example a position such that the camera 103 directly above the target 202A, such that the camera's optical axis 103A is orthogonal to the plane of the target, and the optical axis 103A passes directly through the dot 202D. In this embodiment, the camera 103 is a fixed distance 510 above the bed 102. The computer, through the use of software and the camera 103, locates the center of the dot 202D of target 202A, and measures and records the position of the table 102 e.g., with respect to the camera 103, in the computer's memory. To measure the distance between the camera 103A and the dot 202D of the target 101A, the computer adjusts the lens of the camera 103 until the dot 202D comes into clear focus.

Then the computer moves the table 102 to a position such that the camera 103 is directly above the other target 202B, and locates that target's dot 202D. For example, in FIG. 8D, the CMM has moved the table 102 in the direction of arrow 750 so that the target 202B is beneath the camera 103. The computer then locates the center of the dot 202D of target 202B, and measures and records the position of the table, e.g., with respect to the camera 103, in the computer's memory. With that data, the computer 121 or host processor 130 can calculate the distance 503 between the dots along line 550.

The operator then rotates the artifact 500 180 degrees on the bed 102 (step 603). The artifact remains, essentially, in the X-Z plane, as schematically illustrated for example in FIG. 8B.

The method 600 then takes a second measurement (step 604), essentially similar to the measurement of step 602, except with the now-rotated artifact 500. With the second set of measurement data, the computer 121 or host processor 130 can again calculate the distance 503 between the dots 202D along line 550. The remaining process steps (steps 605-607) process as described previously. A similar process 600 may be used to calibrate the Y-Z plane.

Although the methods described above all describe motions of the camera 103 or table 102, and the focusing of the camera 103, under control of the CMM's controller, in various other embodiments any of those actions may be performed by an operator using the manual controls 125 of the CMM.

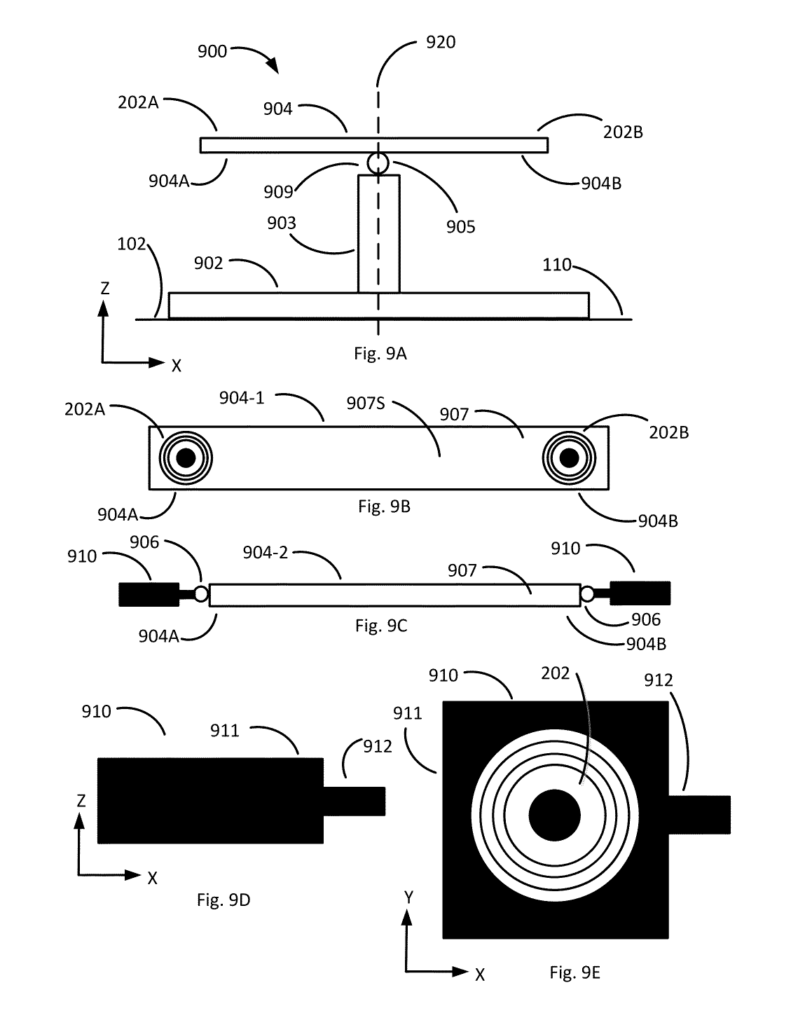

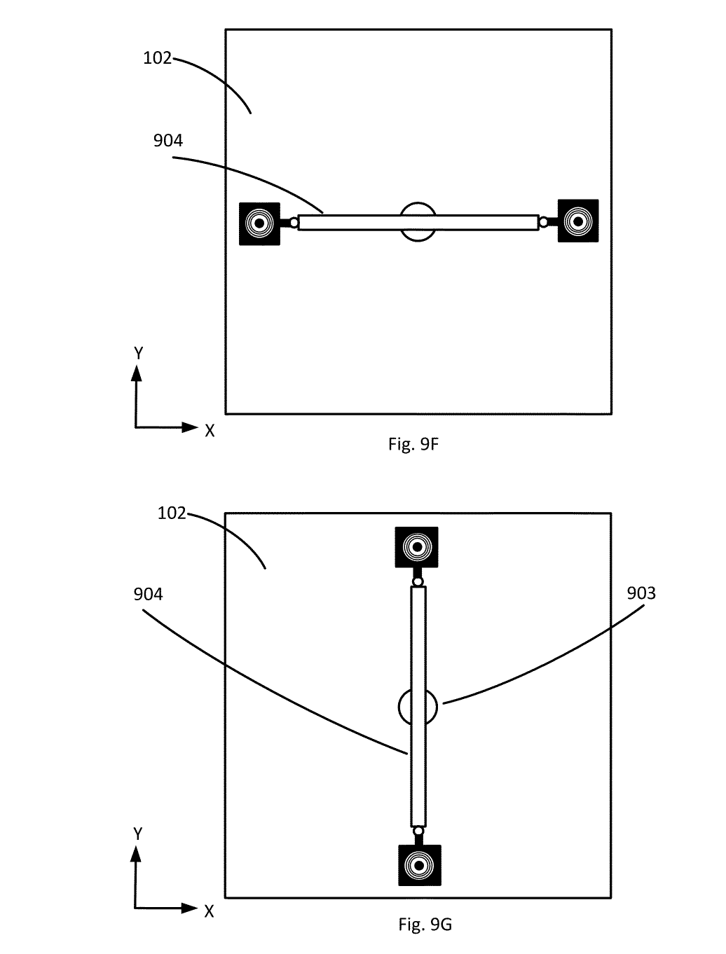

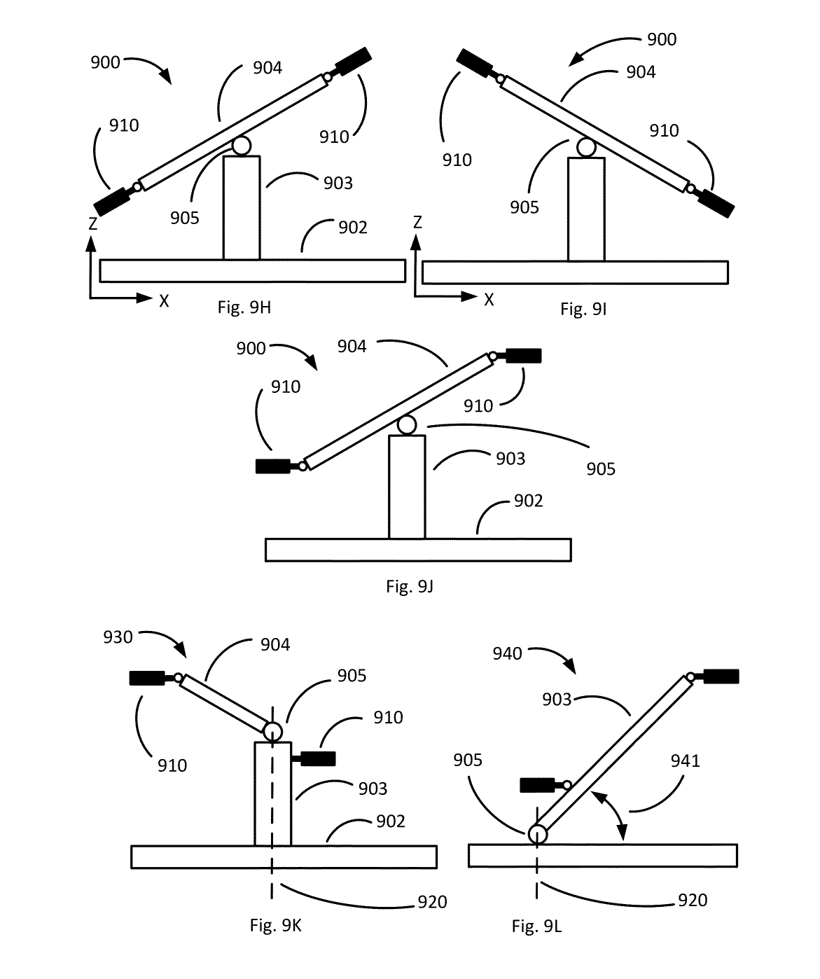

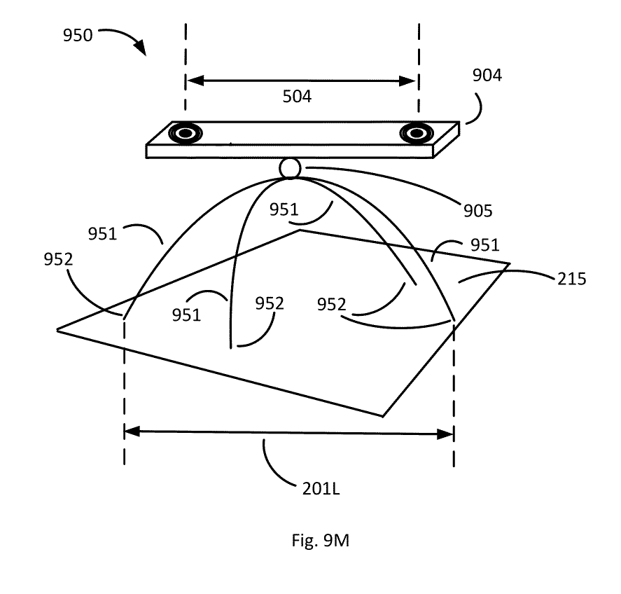

Another embodiment of calibration artifact 900 for calibrating an optical coordinate measuring machine, for example via method 600, is schematically illustrated in FIG. 9A, and includes a base 902 and a vertical support member 903 that supports optical targets 202A and 202B above a table plane 110 of a table 102 of a coordinate measurement machine. In other words, the vertical support 903 supports targets 202A and 202B above the base 902 in a direction that is vertically displaced from the base 102 in a direction away from the table 102.

More specifically, in the embodiment of FIG. 9A, the optical targets 202A and 202B are suspended from the vertical support 903 by a target support arm 904, which is physically coupled to the vertical support 903. As schematically illustrated in FIG. 9A, the targets 202A and 202B are disposed at distal ends 904A and 904B, respectively, of the target support arm 904, although other positions for the targets 202A and 202B are possible.

In some embodiments, the support arm 904 is a beam 907 with targets 202A and 202B on a surface 907S of the beam 907, as schematically illustrated by arm 904-1 in FIG. 9B.

In other embodiments, one or more of the targets is disposed on a target module 910 that is suspended from the arm 904, as schematically illustrated by arm 904-2 in FIG. 9C for example. In the embodiment of FIG. 9C, the target support arm is a beam 907 supporting two optical target modules 910, each of which includes a target 202, as schematically illustrated in FIG. 9E, for example.

In the embodiment of FIG. 9C, each target module 910 includes a body 911 and a mounting tab 912. Each target module 910 is movably coupled to the beam 907 by a joint 906 extending between the beam 907 and mounting tab 912. The target joint 906 is configured to allow the orientation of the target module 910 with respect to the beam 907 to be controllably adjusted, for example such that the target 202 is parallel to the table plane 110 even when the target support arm 904 is not parallel to the table plane, as schematically illustrated in FIG. 9J for example. One benefit of using optical targets 202 to calibrate a CMM is that the physical dimension of the shapes of the targets do not need to be perfect (e.g., circles) and do not need to be calibrated or certified, because the camera 103 can see and identify a target 202 and/or dot 202D even if the target 202 or dot 202D are not in a plane orthogonal to the axis of vision of a camera 103. In other words, calibration of an optical CMM may not require a perfect or near perfect target, or a specific angle of view of a target 202, since the camera 103 can see and identify a target 202 even if the shape of the target or its dot 202D or circles 202R are not perfectly circular, or are elliptical as would be the case if the camera views the target from an angle that is not perpendicular to the plane of the target.

Various embodiments described below include the arm 904-2 of FIG. 9C as the arm 904, although other arms, such as the arm 904-1 in FIG. 9B, may also be used.

In some embodiments, the arm 904 is movably coupled to the vertical support by arm joint 905. In some embodiments, the arm joint 905 is configured to adjust the distance between the vertical support 903 and arm 904 to be adjustable, as schematically illustrated by the gap 909. Alternately, or in addition, in some embodiments, the arm joint 905 is configured to allow the orientation of the target support arm with respect to the base 902, and/or the table 102, to be controllably adjusted. For example, in some embodiments, the target arm 904 is rotatable around and axis 920 perpendicular to the table plane 110. In some embodiments, the arm 904 is rotatable through a fixed angle of 90 degrees, as schematically illustrated in FIG. 9F and FIG. 9G. In other words, the angle though which the arm 904 is rotatable is substantially equal to 90 degrees, and in some embodiments is neither more nor less than 90 degrees.

In other embodiments, the arm 904 is rotatable through a fixed angle of 180 degrees. In other words, the angle though which the arm 904 is rotatable is substantially equal to 180 degrees, and in some embodiments is neither more nor less than 180 degrees. When the arm 904 is rotated by 180 degrees, the two target modules 910 are repositioned, as shown in FIG. 9H and FIG. 9I, for example. In FIG. 9H, the rightmost target module 910 is in a plane above the table plane 110 that is higher than (i.e., further from the table plane 110 than) the leftmost target module 910. In contrast, in FIG. 9I, the leftmost target module 910 is in a plane above the table plane 110 that is higher than (i.e., further from the table plane 110 than) the rightmost target module 910. In FIGS. 9H and 9I, the heights of the target module 910 above the target plane 110 have not changed; only their positions have changed. As such, the targets 202 within the target modules 910 define two calibration reference points visible to and locatable by the camera when the base rests on the table.

FIG. 9K schematically illustrates an embodiment 930 in which one target 910 is suspended from a target support arm 904, while another target 910 is suspended from the vertical support 903. The support arm 904 may optionally be movably coupled to the vertical support 903 by an arm joint 905, as explained in other embodiments described herein. In other embodiments, the arm 903 may be fixedly coupled the vertical support 903, and the vertical support 903 is rotatably coupled to the base 103, such that rotation of the vertical support about the axis 920, which is perpendicular to the base 102 and table plane 110, causes the simultaneous orbit of the targets about axis 920.

FIG. 9L schematically illustrates an embodiment 940 in which a vertical support 904 is physically coupled to the base 902 by an arm joint 905. Two targets 910 are coupled to the vertical support 903 and rotate around the axis 920 with the rotation of the vertical support 903 about that axis. In this embodiment, the vertical support 903 is coupled to the base at an angle 941 less than 90 degrees, for example at an angle 941 of 80 degrees, 70 degrees, 60 degrees, or even 45 degrees or less. In other words, the vertical support 903 supports targets 910 above the base 902 in a direction that is vertically displaced from the base 102 in a direction away from the table 102, even though the vertical support 903 does not extend perpendicular to the base 902.

Some embodiments have a base that does not itself have a planar surface configured to rest upon a table bed 102. For example, an embodiment of a calibration artifact 950 is schematically illustrated in FIG. 9M, and shares many of the features of other embodiments, as indicated by common reference numbers. The base 950 includes a number of legs 950. Each leg has a tip or end 952, and the legs 950 and tips 952 define a base plane 215 in the way that the legs of a table or stool define a plane. Some embodiments 950 have four legs as in FIG. 9M, but some embodiments may have as few as three legs (as in a common stool) and some may have five or more legs.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A calibration artifact for calibrating an optical coordinate measuring machine, the coordinate measuring machine having an object table defining a table plane and an object volume extending from the table plane, and a movable camera, the calibration artifact comprising:
a base defining a base plane, the base plane configured to rest upon the table;
a vertical support coupled to the base, and configured to extend from the base into the object volume;
a first optical target suspended at a first height above the table plane by the vertical support; and
a second optical target suspended at a second height above the table plane by the vertical support and separated from the first optical target, the second height different from the first height;
the first target and the second target configured to define two calibration reference points visible to and locatable by the camera when the base rests on the table.

P2. A calibration artifact according to potential claim P1, further comprising a target support arm extending from the vertical support, the first optical target supported from the vertical support via the target support arm.

P3. A calibration artifact according to potential claim P2, wherein the target support arm is rotatably coupled to the vertical support so as to be controllably rotated about an axis perpendicular to the table plane.

P4. A calibration artifact according to potential claim P3, wherein the target support arm is configured to rotate through a fixed angle of 180 degrees with respect to the base.

P5. A calibration artifact according to potential claim P2, wherein the target support arm is rotatably coupled to the vertical support so as to be controllably rotated in a plane perpendicular to the table plane.

P6. A calibration artifact according to potential claim P5, further comprising a knuckle joint physically coupling the first optical target to the target support arm and configured to allow the first optical target to be adjustable relative to the target support arm so as to be parallel to the table plane even when the target support arm is not parallel to the table plane.

P7. A calibration artifact according to potential claim P5, the first optical target fixedly coupled to the target support arm such that the first optical target is not parallel to the table plane when the target support arm is not parallel to the table plane.

P8. A calibration artifact according to potential claim P1 wherein the vertical suport is fixedly coupled to the base so as to be perpendicular to the table plane when the base rests on the table.

P9. A calibration artifact according to potential claim P1 wherein the vertical support is coupled to the base such that an angle of the vertical support relative to the table plane is less than 90 degrees when the base rests on the table.

P10. The calibration artifact according to potential claim P1, wherein the first target is not parallel to the second target.

P11. A calibration artifact according to any of potential claims 1-10, wherein the base includes a plurality of legs, each leg having a leg tip, the plurality of leg tips defining the base plane.

P21. A method of calibrating a machine-vision coordinate measuring machine, the coordinate measuring machine having a bed defining a bed plane, and a machine-vision camera, the method comprising:

placing a calibration artifact on the bed, the calibration artifact lying in the bed;

taking a first measurement, by:

locating the first target with the camera, and recording first position data in a computer memory;

locating the second target with the camera, and recording second position data in the computer memory;

rotating the calibration artifact around an axis perpendicular to the bed plane;

taking a second measurement, by:

locating the first target with the camera, and recording third position data of the first target in a computer memory;

locating the second target with the camera, and recording fourth position data of the second target in the computer memory;

calculating a first measured distance between the first target and the second target using the first position data and the second position data;

calculating a second measured distance between the first target and the second target using the third position data and the fourth target position data;

comparing the first measured distance to the second measured distance to determine whether the first measured distance is equal to the second the measured distance; and

calculating at least a first correction value in response to the comparison of the first measured distance to the second measured distance, the first correction value configured to update a measurement of, or location data describing the position of a point on or feature of, another object.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A calibration artifact for calibrating an optical coordinate measuring machine, the coordinate measuring machine having an object table defining a table plane and an object volume extending from the table plane, and a movable camera, the calibration artifact comprising:
a base having base length, and a surface defining a base plane;
a first optically visible target coupled to the base and disposed in a first plane, the first plane parallel to the base plane; and
a second optically visible target and coupled the base, the second target:
separated from the first target by a nominal distance along the base length, and
the second target disposed in a second plane, the second plane parallel to the first plane,
the first target and the second target configured to define two calibration reference points visible to and locatable by the camera when the base rests on the table.

2. A calibration artifact according to claim 1, wherein the second plane is displaced from the first plane in a direction normal to the first plane.

3. A calibration artifact according to claim 1, and further comprising:
a vertical support coupled to the base, and configured to extend from the base into the object volume, the vertical support coupled to the first target and suspending the first target within the object volume.

4. The calibration artifact according to claim 1, wherein the first target is parallel to the second target.

5. The calibration artifact according to claim 4, wherein the first target and the second target are not parallel to the table plane.

6. The calibration artifact according to claim 1, wherein the base length is fixed.

7. The calibration artifact according to claim 1, wherein the base length is controllably adjustable.

8. The calibration artifact according to claim 7, wherein the base comprises a first base member and a second base member, the first base member movable with respect to the second base member, and wherein the first target is coupled to the first member and the second target is coupled to the second member.

9. The calibration artifact according to claim 8, further comprising a locking mechanism whereby the length can be fixed.

10. The calibration artifact according to claim 1, further comprising at a first target module, the first target module comprising a substrate and the first target.

11. The calibration artifact according to claim 1, wherein the first target comprises a plurality of concentric rings around a center point.

12. The calibration artifact according to claim 11, wherein the first target further comprises a bull's-eye at the center point.

13. A method of calibrating a machine-vision coordinate measuring machine, the coordinate measuring machine having a bed defining a bed plane, and a machine-vision camera, the method comprising:
placing a calibration artifact on the bed, the calibration artifact lying in the bed plane and comprising the calibration artifact of claim 1;
taking a first measurement, by:
locating the first target with the camera, and recording first position data in a computer memory;
locating the second target with the camera, and recording second position data in the computer memory;
rotating the calibration artifact around an axis perpendicular to the bed plane;
taking a second measurement, by:
locating the first target with the camera, and recording third position data of the first target in a computer memory;
locating the second target with the camera, and recording fourth position data of the second target in the computer memory;
assessing the accuracy of the machine vision coordinate measuring machine using the first position data, the second position data, the third position data and the fourth position data.

14. A method of calibrating a machine-vision coordinate measuring machine according to claim 13, wherein assessing the accuracy of the machine vision coordinate measuring machine comprises:
calculating a first measured distance between the first target and the second target using the first position data and the second position data;
calculating a second measured distance between the first target and the second target using the third position data and the fourth target position data; and
comparing the first measured distance to the second measured distance to determine whether the first measured distance is equal to the second the measured distance.

15. A method of calibrating a machine-vision coordinate measuring machine according to claim 13, wherein:
locating the first target with the camera, and recording the position of the first target in a computer memory, comprises locating the first target with the camera, the camera spaced a fixed distance above bed plane, and recording a first camera position data;
locating the second target with the camera and recording the position of the second target in the computer memory, comprises locating the second target with the camera, and recording a second camera position data;
locating the first target with the camera, and recording a third position of the first target in a computer memory, comprises locating the first target with the camera, the camera spaced a fixed distance above bed plane, and recording a third camera position data; and
locating the second target with the camera, and recording a third position of the second target in the computer memory, comprises locating the second target with the camera, and recording a fourth camera position data.

16. A method of calibrating a machine-vision coordinate measuring machine according to claim 15, wherein recording a camera position comprises storing data about the camera's position along the X axis and along the Y axis and along the Z axis, and storing data relating to the focus of the camera.
